(19) United States
(12) Patent Application Publication
(10) Pub. No.: US 2012/0036023 A1
(43) Pub. Date: Feb. 9, 2012

(54) SYSTEM FOR CONDUCTING DEMAND-SIDE, REAL-TIME BIDDING IN AN ADVERTISING EXCHANGE

(75) Inventors: Shirshanka Das, San Jose, CA (US); Michael Ortega-Binderberger, Sunnyvale, CA (US); Sunil Nagaraj, Sunnyvale, CA (US); Swaroop Jagadish, Santa Clara, CA (US)

(73) Assignee: Yahoo! Inc., Sunnyvale, CA (US)

(21) Appl. No.: 12/850,360

(22) Filed: Aug. 4, 2010

(51) Int. Cl. G06Q 30/00

(52) U.S. Cl. 705/14.71

(57) ABSTRACT

A method for conducting demand-side, real-time bidding includes: constructing an exchange graph (G) of nodes representing publishers and third-party advertisers that provide third-party ads, the graph including directed edges connected between the nodes that represent bilateral business agreements; receiving an opportunity for displaying an ad to a user that is associated with a publisher node; exploring the graph to identify third-party ads reachable from the publisher node through a valid path of the exchange graph with which corresponding third-party advertisers are thereby eligible to bid on the opportunity; retrieving statistics from the memory associated with historical selectivity of demand predicates for the third-party ads; and initiating, before beginning graph exploration on at least some paths to the third-party ads, a call out for bids from at least some of the third-party advertisers for the corresponding third-party ads that are unlikely to be discarded during the graph exploration based on the historical selectively of the demand predicates corresponding thereto, thereby reducing latency in time to execute an auction to fill the opportunity.

### RELATED APPLICATIONS

The present disclosure is related to U.S. patent application Ser. No. 12/749,151, entitled EFFICIENT AD SELECTION IN AD EXCHANGE WITH INTERMEDIARIES, filed Mar. 29, 2010, which is hereby incorporated by reference.

### BACKGROUND

1. Technical Field

The disclosed embodiments relate to an ad exchange auction within a directed graph, and more specifically to demand-side, real-time bidding in an advertising (ad) exchange that reduces latencies associated with calling out for bids and executing the auction.

2. Related Art

In advertising auctions, publishers create display opportunities for online advertising on their web pages, which are published to the Internet (or World Wide Web). These include an inventory of advertising slots, also referred to as advertising supply. Advertisers have a demand of advertisements (ads) with which they want to fill the advertising slots on the publisher web pages. The ads of the advertisers may be matched, in real time, with specific display opportunities in an ad exchange, which may simultaneously target specific users as executed in contemporary exchanges. More recently, the ad exchange has been growing in complexity as external ad-networks have been inserted into the exchange, and the number of third-party advertisers has grown. The interaction of publishers (opportunity providers) with advertisers and third party advertisers (ad providers) with intermediate ad-network entities, which buy and sell ads, and with users that consume the ads may be thought of as an online advertising marketplace.

The exchange operates by allowing publishers, advertisers, and the ad-networks to express their business intent. Publishers describe their inventory and their acceptable business constraints; advertisers provide their creatives and express targeting parameters with corresponding bids to the exchange. The ad-network entities in a sense act both as publishers, offering the inventory of their participating publishers, and as advertisers, buying inventory for their advertisers.

More specifically, an ad-network is a business that manages both publishers and advertisers and works to serve ads on publisher pages. In some cases, the ad-network also operates an exchange on behalf of a collection of publisher customers and a collection of advertiser customers, and is responsible for ensuring that the best, valid ad from one of its advertisers is displayed for each opportunity that is generated in real time by one of its publishers. Traditionally, an ad-network would do this by running its own ad servers, but now it can instead delegate its ad-serving responsibilities to an ad-exchange such as Yahoo! of Sunnyvale, Calif., which can be viewed as a “meta-ad-network” that operates on behalf of a collection of ad-networks, and transitively the publishers and advertisers managed by those ad-networks, plus some “self-managed” publishers and advertisers that participate directly in the ad-exchange.

While each ad-network may operate as an ad exchange, ad-networks in general do not want the trouble and expense of running their own ad servers required to execute the ad exchange. The ad-networks still want, however, a simple method for setting up pairwise, opportunity-forwarding agreements, with automatic mechanisms for revenue sharing and for ensuring the consistent application of business logic that keep their publishers and advertisers satisfied, despite the participation of publishers and advertisers of other ad networks. Setting up such opportunity-forwarding agreements in an automated fashion ensures additional revenue sharing opportunities for publishers and advertisers. If the pool of publishers and advertisers can be cross-expanded with other ad networks, as well as with third-party advertisers, each ad-network benefits economically to a great extent. To provide this economic benefit without the concomitant costs and resources of running a server to adequately do so, the meta-ad-network operates as a meta-ad-exchange to connect publishers and advertisers across multiple ad-networks.

The meta-ad-exchange (or “exchange” for simplicity) operates one or more ad servers, which have required more resources as the number of participating ad-networks, publishers, and advertisers has grown. The business relationships between these entities can be represented in the exchange as an exchange graph including nodes that represent the ad-networks, the publishers, and the advertisers. Additionally, the exchange graph includes edges that connect the nodes that may include one or more targeting predicates, which in a broadest sense, are the parts of propositions that are affirmed or denied about a subject. Such a subject in this case could be a constraint or requirement of some kind, such as arising from a contract or other business relation germane to the meta-ad-network. The nodes of the graph may also include targeting predicates, and the combination of the predicates in the nodes and edges of a graph must be satisfied to create a legal path through the graph.

In years past, the exchange would be run by static bidding with long-running campaigns and through use of coarse granularity in the user targeting dimensions, which would limit the agility and effectiveness of participation in the exchange. The use of a static bidding model allows for efficient serving but at the expense of bidding precision and optimal economic efficiency. Market participants, such as third-party advertisers and publishers, would endure hours of delay when targeting or biding decisions change due to delays in distributing new static metadata to the serving (delivery) systems. For user targeting, the exchange has had fixed categories to classify users, preventing advertisers from using enhanced targeting information. Part of this limitation has been due to technical restrictions, but a significant limiting aspect has been the reticence of participants to share their hard-won proprietary user data with the exchange itself. As such, this data is unavailable for targeting by the meta-ad-exchange during ad fulfillment; the result has been a suboptimal marketplace.

In a simplistic scenario of ad selection, the exchange graph 200 is “flat,” like a classical ad-network shown in FIG. 3, meaning that advertisers 104 and publishers 108 can be directly matched up during any given ad serving transaction, subject to feasibility and optimality requirements, which can be the subject of the predicates. Additionally, the exchange graph has practically become much more complicated through the introduction of the ad-network entities discussed above. Determining the legality of a path between an advertiser node and a publisher node, and calling out for bids to advertisers having valid ads can be work intensive and create latencies in the auction process.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the present disclosure. In the drawings, like referenced numerals designate corresponding parts throughout the different views.

FIG. 1 is a block diagram of an exemplary system for conducting demand-side, real-time bidding in an ad exchange.

FIG. 2 is a block diagram of the system of FIG. 1 for conducting demand-side, real-time bidding in an ad exchange, including detail of the web server and ad exchange server.

FIG. 3 is a prior art exchange graph diagram showing the classic “flat” ad matching problem.

FIG. 4 is an exchange graph diagram showing an ad matching problem that includes intermediate ad-network entities.

FIG. 5 is a diagram of a directed multigraph showing some of the main features of the exchange graph that includes intermediate ad-network entities.

FIG. 6 is another exchange graph diagram, showing a counterfactual scenario where the exchange contains no legality constraints.

FIGS. 7A, 7B, 7C, and 7D is a series of related exchange graph diagrams, showing the progression of a core algorithm for ad selection of a sample ad in an ad exchange having intermediate ad-network entities.

FIGS. 8A, 8B, and 8C are flow diagrams of an exemplary method for efficient ad selection in an ad exchange with intermediate ad-network entities, according to an embodiment.

FIG. 9 is a flow chart of an exemplary method for conducting demand-side, real-time bidding in an ad exchange server.

FIG. 10 illustrates a general computer system, which may represent any of the computing devices referenced herein.

### DETAILED DESCRIPTION

By way of introduction, included below is a system and methods for conducting demand-side, real-time bidding in an ad exchange. As discussed above, for demand-side real-time bidding (RTB), network bandwidth is one of the primary factors contributing to the cost of ad serving (delivery). As a result, it is desirable to make the bid call out to an ad only when participation in the auction is guaranteed after evaluation of all targeting predicates. One of the principles of determining legality of an (ad, path) pair, which will be discussed in more detail below, is to do so as lazily as possible in order to reduce the number of evaluations. This includes eliminating some ads, including third-party ads from third-party advertisers, which the exchange server determines will not be valid or are likely to not win the auction, without further analysis with regards to those ads. Accordingly, the evaluation of certain of the targeting predicates is interleaved with the auction process so that an early termination can avoid unnecessary evaluation of targeting predicates for ads which cannot outbid the other participants. This lazy evaluation results in significant latency savings in the average auction due to early termination.

Unlike many other ad-networks and “flat” exchanges, Yahoo!'s Non-Guaranteed (NGD) Exchange contains not only publishers and advertisers, but also intermediate ad-network entities that can link together publishers and advertisers that do not have a direct relationship. The NGD Exchange has recently experienced significant growth in impressions and revenue. An impression is created any time a user is exposed to an ad, e.g., a web page is downloaded on the browser of the user containing an advertisement. Each ad includes a creative or image of some kind, usually some text, and a uniform resource locator (URL) link to a landing page of the advertiser associated with the ad.

Given the recent business growth, the NGD ad exchange server as previously-executed exhibited scalability and performance problems. A solution was needed that uses existing serving interfaces and front-end/back-end data structures to support the growth of business by scaling gracefully with business metadata, and ultimately to support the NGD exchange with greater depth. Also desired were lower latencies and larger query per second (QPS) rates per ad server. Likewise, the NGD exchange servers needed to support a latency-bounded model that allows for revenue versus latency trade-offs through simple run-time adjustments, also referred to herein as knobs. Finally, designers sought to formulate the exchange serving abstractions and architecture of the NDG exchange in a manner so as to decouple the exchange network marketplace (entities, business relationships, constraints, budgets) from the ad marketplace (advertiser bids, response prediction, creatives).

As discussed, the ad exchange includes publishers and advertisers, as well as intermediate ad-network entities, all represented in an exchange graph with nodes, and further includes edges that interconnect the nodes, thus creating a multiplicity of possible paths. The edges include predicates with which compliance is required in order to traverse the path to fill an opportunity with a specific advertisement from a specific advertiser. This is a more complicated scenario than a “flat” ad exchange: the predicates associated with edges along a path include intermediaries that introduce complications into ad selection that are often intractable in resolution. This is because now, not only must a winning advertiser bid be chosen, but a winning (ad, path) pair needs to be found to maximize profit to the publisher that generated the opportunity while also meeting all legality predicates along that path.

Moreover, the legality of a path depends not only on the individual legality of the edges of a path given the current display opportunity, but also on constraints that allow edges to have veto power over the endpoints of the path, which are additional predicates. In the ad serving role, therefore, an exchange needs to, in real time and with low latency, select an ad and a path leading to that ad, subject to feasibility and optimality requirements which can depend on the characteristics of the particular user who is at that moment loading a web page from a website of a publisher.

Proposed herein is an efficient, polynomial-time algorithm for solving this constrained path optimization problem so as to provide a scalable—and low latency—ad serving solution. Despite the fact that the number of candidate paths can grow exponentially with graph size, this algorithm exploits the optimal substructure property of best paths to achieve a polynomial running time. To further improve its speed in practice, the algorithm also employs a search ordering heuristic that uses an objective function to skip certain unnecessary work. Experiments on both synthetic and real graphs show that compared to a naive enumerative method, the speed of the proposed algorithm ranges from roughly the same to exponentially faster.

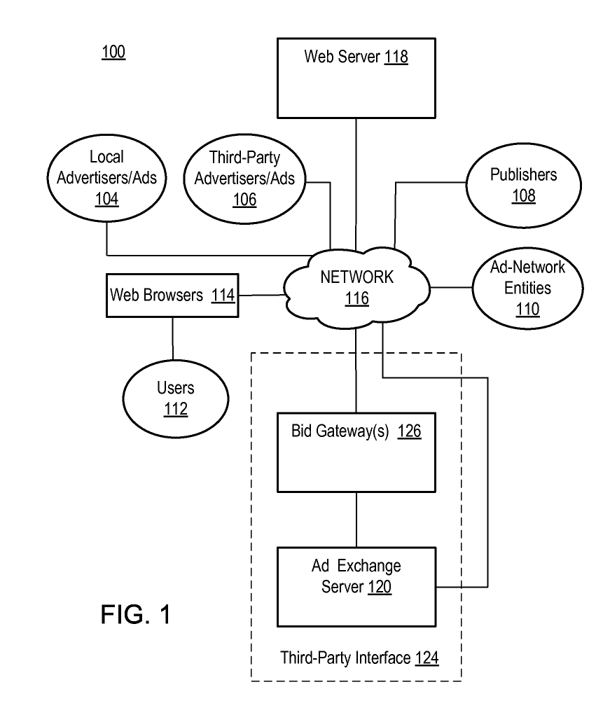

As shown in FIG. 1, a system 100 for conducting demand-side, real-time bidding in an ad exchange includes a plurality of local advertisers 104, third-party advertisers 106, publishers 108, ad-network entities 110, and users 112 that access web pages on publisher websites through web browsers 114 over a communications network 116. The users 112 may access and download web pages on their client computers or other network-capable computing device, such as a desktop, a laptop, or a smart phone or other wireless device (not shown). The communications network 116 may include the Internet or World Wide Web (“Web”), a wide area network (WAN), a local area network (“LAN”), and/or an extranet or other network.

The system 100 includes a web server 118, which may include a search engine as well as general delivery of publisher web sites browsed to by the Web users 112, and includes one or more ad exchange server 120 such as already briefly discussed, all of which are coupled together, either directly or over the communications network 116. In some embodiments, the system 100 includes a third-party interface (3PI) 124, which includes at last part of the ad exchange server 120 in addition to at least one or more bid gateways 126, in addition to other co-located traffic managers (not shown). The ad server 120 may connect to the communications network 116 through one or more bid gateways 126, which may be coupled with the web server 118 and other network entities over the network 116. Herein, the phrase “coupled with” is defined to mean directly connected to or indirectly connected through one or more intermediate components.

The ad exchange server 120 may be integrated within the web server 118 in some embodiments. The ad exchange server 120 receives a request from the web server 118 for ads to be delivered to a search results or other web page in response to a query submitted by a user 112 or to a browsing or linking action that led the user 112 to download a publisher web page. The request creates an advertisement display opportunity, whether on a search results page or another web page of a publisher website. Accordingly, the web server 118 may host one or more affiliate publishers 108.

The 3PI 124 subsystem of the exchange removes the serving and economic inefficiencies referred to in the background section above. It does so by delegating to advertiser (or other customer) infrastructure (not shown) the duties of computing a bid and a creative at ad call time. The 3PI 124 accomplishes this by calling out to the bidding agent of the advertiser 104, 106, which may include an ad-network 110, during each ad call where that advertiser could participate.

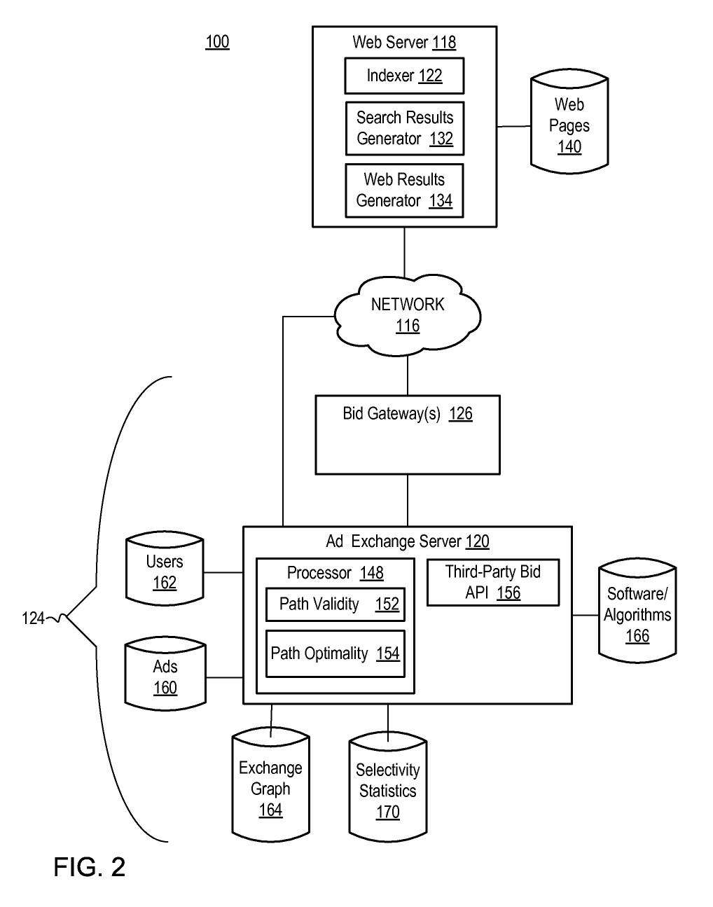

FIG. 2 displays the system 100 of FIG. 1 for conducting demand-side, real-time bidding (RTB) in an ad exchange, including an increased level of detail in the web server 118 and ad exchange server 120. The web server 118 may include an indexer 128 or the indexer may be executed remotely on another computing device, and be coupled with the web server 118 over the network 116. The web server 118 may further include a search results generator 132, a web page generator 134, a communication interface 136, and a web pages database 140. The indexer 128 indexes the web pages of the database 140 according to key word terms that relate to the content of the web pages and are search terms for which the users 112 are likely to search.

The indexer 128 indexes the web pages stored in the web pages database 140 or at disparate locations across the communications network 116 so that a search query executed by a user will return relevant search results. When a search is executed, the search results generator 136 generates web results that are as relevant as possible to the search query for display on the search results page. Indeed, organic (or algorithmic) search results are ranked at least partially according to relevance. Also, when the search query is executed, the web server 118 requests relevant ads from the ad exchange server 120 to be served in sponsored ad slots of the search results page.

If a user browses or links to a publisher website, which may be through a search results page, a search engine page, or any other publisher website, the web page generator 134 supplies the web page for download by the user 112 accessing the same. Before supplying the web page, however, the web server 118 requests that the ad exchange server 120 deliver an ad that may be not only relevant to the web page being downloaded, but also that somehow targets the user downloading the web page. This is what is known as a server-side ad call. In another example, the publisher web server 118 generates a page with a number of holes or ad slots in them, which, when rendered by the browser of the user 112, triggers ad calls to the ad exchange server 120 to fill those ad slots. This is known as a client-side ad call. Again, either the server-side or client-side ad call creates an ad display opportunity, which requires that the ad exchange server 120 process the ad exchange graph to compute bids from advertisers for ads that are valid for the opportunity. The ad exchange server 120 internally runs an auction on behalf of the publisher that supplied the opportunity. Therefore, the publisher 108 is the entity which gets paid, and the auction winner is the candidate advertiser 104 that causes the publisher 108 to be paid the most.

The ad exchange server 120 may include a processor 148, including modules for resolving path validity 152 and path optimality 154, and a third-party bid application programming interface (API) 156. Path optimality may also be referred to as maximizing the amount a publisher is paid with the chosen path through an exchange graph. The ad exchange server 120 may further include an advertisements (ads) database 160, a users database 162, an exchange graph database 164, and other system storage 166 for software and algorithms executed by the ad exchange server 120 when conducting ad selection for advertisement display opportunities. The exchange server 120 may also include a selectivity statistics database 170.

Ads are stored in the ads database 160, which include a variety of properties associated with and stored in relation to the ads. User metadata and click history may be stored in relation to specific users in the users database 162, which includes interests and aspects of users that will generally be referred to as user properties. Exchange graph information, including predicates related to business relationships of participants in the exchange, are stored in mutual relation in the exchange graph database 164. These predicates include demand predicates and supply predicates, as well as legality predicates.

A demand predicate may be a function whose inputs include properties of one or more of the ads. The properties of the ads, therefore, are targetable by one or more demand predicates. A supply predicate may be a function whose inputs include properties of a user. The properties of the users, therefore, are targetable by one or more supply predicates. A legality predicate may be a Boolean AND of a supply predicate and a demand predicate at a node or edge of an exchange graph. Predicates may constrain both nodes and edges of an exchange graph. The selectively statistics database 170 stores statistics data related to the degree to which the predicates have influenced path and/or ad selection in the past, and which can provide insight to making decisions prospectively before analyzing the legality of actual paths through the exchange graph. The databases may be stored in memory or other storage coupled with the ad exchange server 120.

The third-party bid API 156 may be included as part of the exchange server 120, or may be otherwise coupled therewith in the third-party interface 124 infrastructure. The third-party bid API 156 is used to define the data elements that are exposed to third party advertisers to enable them to customize a bid for a given opportunity. The third party bid API 156 is formulated as a request-response pair designed to ensure that the amount of data transmitted is necessary and sufficient for effective third-party bidding. There are two reasons for this approach: 1) expensive call outs to a third party advertiser 106 necessitate a single request-response round trip per bidding opportunity, and 2) proprietary data ownership by Yahoo! and third party advertisers 106 dictates that only necessary information is transmitted to ensure minimal data sharing.

After some development efforts, a common set of attributes were developed for the bidding opportunity that was both interesting to the third party advertisers 106 for customizing their bids, and amendable to sharing from the perspective of the publishers 108. In summary, there were two categories of bid opportunity attributes developed, which follow. First are attributes relevant to third party advertisers 106 and amenable to sharing by publishers 108, e.g., user-specific attributes like IP addresses and publisher-specific attributes like the URL where an ad will be shown. These attributes may be subject to some privacy-based obfuscation pursuant to publisher/third-party data sharing agreements. Second are attributes that serve to unlock the value of the third-party advertiser 106 proprietary data, e.g., the exchange identifier for the user that third-party advertisers 106 can use to target ads based on their knowledge of the user.

Additionally, requests and responses are signed for, both in terms of integrity and authentication, to prevent threats such as in-flight changes of bid amounts and reverse engineering of third-party advertiser bidding by outsiders.

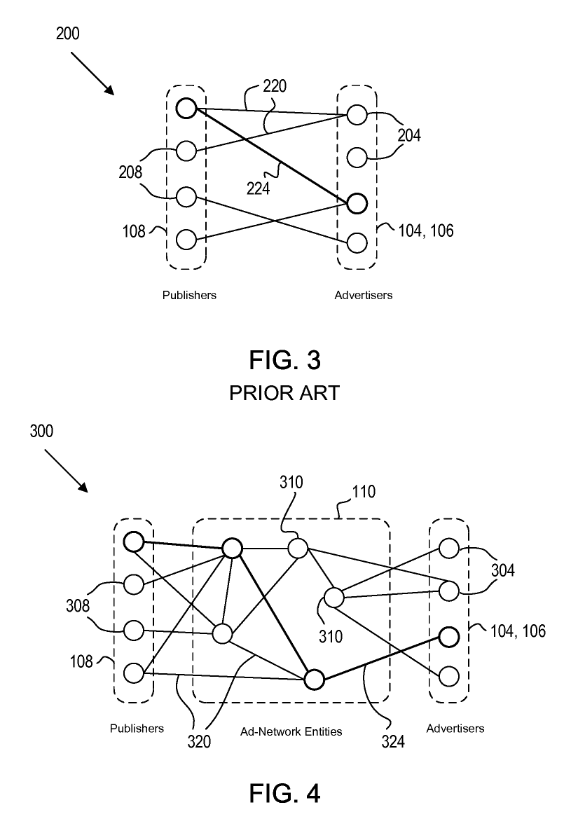

FIG. 3 is a diagram of a prior art exchange graph 200 showing the classic “flat” ad matching problem already discussed in the related art section above. A plurality of nodes 208 represents the publishers 108 and a plurality of other nodes 204 represents the advertisers 104, 106 and their ads. A plurality of graph edges 220 represent interconnections directly between advertisers 104, 106 having ads that meet the legality and optimality requirements to fill display opportunities provided by the publishers 108. The ad exchange server 120 finds the optimal and legal path 224 between an opportunity of a publisher 108 and a specific advertisement of an advertiser 104, 106 as discussed above. As discussed, this “flat” ad matching problem is the classic, more simplistic scenario that is relatively easy to solve.

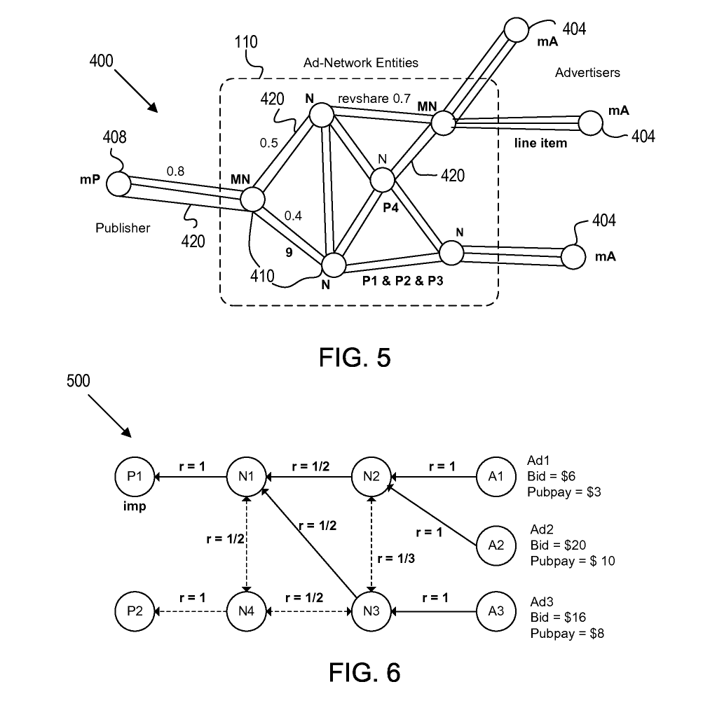

FIG. 4 displays a diagram of an exchange graph 300 showing an ad matching problem that includes intermediate ad-network entities 110 in addition to the publishers 108 and advertisers 104, 106. Similar to FIG. 2, the exchange graph of FIG. 3 includes nodes 308 that represent the publishers 108 and nodes 304 that represent the advertisers 104, 106. The added complexity in this exchange graph diagram 300 comes from the addition of nodes 310 that represent intermediate ad-network entities 110. A plurality of graph edges 320 interconnects the nodes 304, 310, 308 of the advertisers 104, 106, the ad-network entities 110, and of the publishers 108, respectively. The ad exchange server 120 finds the optimal and legal path 324 through the exchange graph, which thus meets a plurality of legality predicates as discussed above, and maximizes payout to the publisher 108 providing an identified display opportunity.

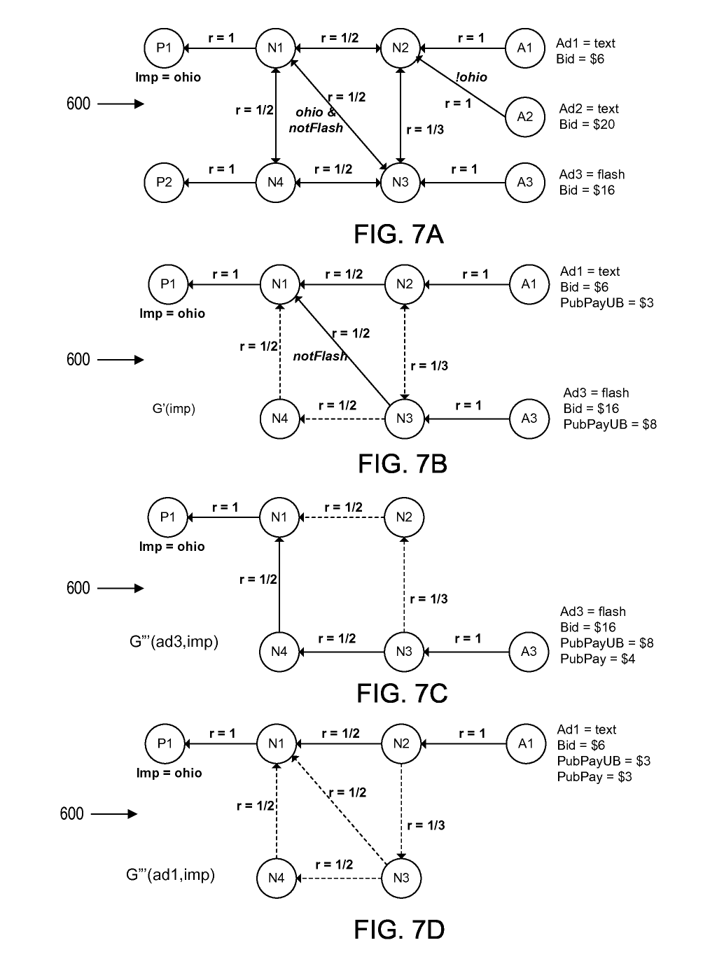

FIG. 5 is a diagram of a directed multigraph 400 showing some of the main features of the exchange graph that includes intermediate ad-network entities 110. A publisher node 408 represents the publisher 108 from which the ad exchange server 120 has received an ad display opportunity. The publisher 108 in this example is a “managed” publisher, meaning that the publisher 108 is managed over the network 116 by an intermediary ad-network entity 110 that set up that publisher 108 in the system 100. A number of advertisers 104, 106 are in contention in bidding for the opportunity; these advertisers are also considered “managed” advertisers and are represented by a plurality of nodes 404. A number of the ad-network entities 110 are represented by a plurality of nodes 410. The union of these entities—the publishers 108, the advertisers 104, and the ad-network entities 110—together with potential links between the same is a directed multigraph. A multigraph is a multiset of unordered pairs of (not necessarily distinct) nodes. Directed refers to an asymmetric relation within the edges of the graph, thus creating a certain direction to connect an advertiser node 404 to a publisher node 408, an advertiser node 404 to an ad-network node 410, and/or an ad-network node 410 to a publisher node 408, which connections are provided through a plurality of path edges 420. The participants in the auction are actually pairs, each including an ad, and a path in the exchange graph 400 that connects the publisher 108 of the impression with the advertiser 104, 106 of the ad.

The nodes and edges of the multigraph 400 of the ad exchange contains many predicates (encoding business logic) that determine whether a given ad and path are legal for the current impression. These are also referred to as targeting predicates, which may exist in the nodes 404, 408, 410, the edges 420, and in the creatives of the ads, as well as in revenue sharing requirements on the edges 420. In the ad exchange, before implementation of the present methods and algorithms, the resulting constraint satisfaction problem was computationally intractable (NP-hard). The method of choice for solving such problems, if one must, is an exponential-time backtracking algorithm.

A major part of the current design project was a thorough review of all NGD exchange features to determine which ones are sources of the intractability mentioned above. In early stages of the design work, all such features were simply removed to create an efficiently solvable “core task.” That made it possible to design a corresponding polynomial-time “core algorithm.” Subsequently, all of the deleted features had to be re-instated, but with restrictions that prevented the re-introduction of intractability. Several examples of these feature modifications are discussed below.

$$\begin{matrix}pubPay ( ( Ad , Path ) \vert imp ) = Bid ( Ad \vert imp ) \times {\prod }_{edge ∈ Path} Re vShare ( edge ) & ( 1 ) \\ Legal ( ( Ad , Path ) \vert imp ) = Legal ( Ad \vert imp ) ⋀ {\prod }_{x ∈ Path} ( Legal ( x \vert imp ) ⋀ Legal ( x \vert Ad ) ) & ( 2 )\end{matrix}$$

The per-ad-call NGD auction can be formalized as a constrained optimization problem defined by an objective function pubPay((Ad,Path)|imp) and a legality function Legal((Ad,Path)|imp), shown in Equations 1 and 2, respectively. To explain the objective function in more detail, consider a bid by an advertiser, tⱼ, as an offer to pay money to a publisher 108 to show an ad to a user 112 having certain properties, x_{q}. A multiplier for a single edge along each path is designated as m(e) and falls in the interval (0, 1). Accordingly, a multiplier for an entire path is designated as M(p) and is given as Π_{eεp}m(e). Using this construct and notations, the score for an entire path between the opportunity and the ad is given as:

Score(x_{q},p)=B(x_{q},t(p))·M(p) (3)

This score represents the money actually received by the publisher 108 after a fraction of (1−M(p)) of the money is diverted to intermediate ad-network entities 110. Accordingly, the objective function broadly written as Equation 1 seeks to maximize what the publisher is paid by choosing the path that shares the least revenue to the intermediate ad-network entities 110. This is the same as maximizing the score as expressed in Equation 3.

Depending on the details of the two functions in Equations 1 and 2, the constrained optimization problem can either be tractable or not. In the previously-implemented ad exchange, this problem was intractable (NP-hard). Equations 1 and 2 define a limited “core” version of the constrained optimization problem solvable by the ad exchange server 120 in polynomial time due to several simplifications and assumptions, some of which include:

1. Every graph edge is a “revenue share” edge that transmits a specified fraction of the money entering the edge.

2. The revenue share of a path is the product of the revenue shares of its edges. In some cases, one or more nodes of a path also include revenue shares that are multiplied into the product of revenue shares of the edges for the overall revenue share of the path.

3. The payment to the publisher is the bid of the advertiser times the revenue share of the path.

4. The legality of a path is an AND of the individual legality of every node and edge in that path.

5. The legality of a given node or edge generally depends on properties of the current impression and properties of a specific ad, both of which are fixed for the duration of the ad call.

6. More specifically, the legality of a given node or edge is defined to be the AND of two subpredicates, a supply predicate and a demand predicate, which respectively depend on properties of the impression and properties of the ad, respectively.

Points 1-3 are assumptions about the objective function, which allow it to be treated as an efficiently-solvable, min-cost path problem. Points 4-5 are assumptions about the constraints, which allow them to be handled by graph thinning, discussed below. Point 6 allows the impression-dependent “supply predicates” and the ad-dependent “demand predicates” to be handled by successive rounds of graph thinning.

Let N and E denote the number of nodes and edges in the directed multigraph that represent the ad exchange. Let A denote the number of ads in the ad pool, which is a group of ads that are available to bid on an impression generated by a publisher. All run times will be stated under the assumption that N<E. The Õ( ) notation indicates that log factors are suppressed in the cost analysis.

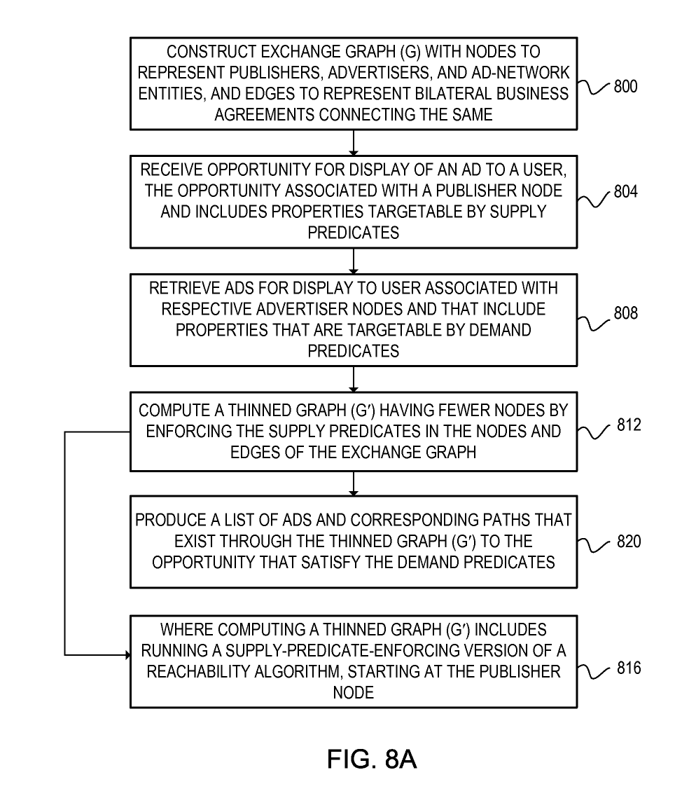

If there were no legality constraints at all, the problem could be solved in Õ(E+A) time by first running a minimum-cost-path algorithm, such as single-source Dijkstra, to simultaneously find optimal paths from the current publisher to every advertiser, then multiplying the revenue shares (revshares) of these optimal paths by the bids of the A ads to obtain A values of pubPay(ad,bestpath(P,advertiser(ad))), and finally picking the maximum such value. This scenario is depicted in FIG. 6, which displays a counterfactual scenario where an exchange graph 500 contains no legality constraints; the full best-path tree (drawn in solid lines) from P1 to all advertisers could be constructed in Õ(E) time by one single-source Dijkstra computation. The ad-path pair (ad2, bestpath(P1,A2)) would be the auction winner because its publisher payment of 10 dollars (1*0.5*1*20) dollars is maximal.

Dijkstra's algorithm is a graph search algorithm that solves the single-source shortest path problem for a graph with nonnegative edge path costs, producing a shortest path tree. This algorithm is often used in routing. For a given source vertex (node) in the graph, the algorithm finds the path with lowest cost (e.g., the shortest path) between that node and every other node. It can also be used for finding costs of shortest paths from a single node to a single destination node by stopping the algorithm once the shortest path to the destination node has been determined. For example, if the nodes of the graph represent cities and edge path costs represent driving distances between pairs of cities connected by a direct road, Dijkstra's algorithm can be used to find the shortest route between one city and all other cities. As a result, the shortest path is used first in network routing protocols.

If there were legality constraints of the limited form described in Equation 2 and points 4-6, but no ad-dependent predicates, then the problem could again be solved in Õ(E+A) time as follows: run the same algorithm, but this time on a thinned graph G′(imp) obtained from the original graph, G, by deleting all edges and nodes that are not legal for the current impression.

Since the exchange graph can in fact contain ad-dependent predicates, in the worst case single-source single-sink Dijkstra should be run A times to find optimal legal publisher-to-advertiser paths in A different thinned graphs G″(ad, imp). The resulting Õ(A·E) worst case run time for one ad call is effectively quadratic and therefore unacceptable.

The factorization of predicates mentioned in point 6 discussed above can help in several ways. For example, the constant factor can be improved by a “progressive thinning” scheme that first converts G to G′(imp) by applying the impression-dependent predicates, then builds each G″(ad, imp) by applying the ad-dependent predicates to G′(imp).

Another useful strategy begins by using single-source Dijkstra to compute a best path tree from the publisher in G′(imp). The revshare of an optimal path in G is at least as good as the revshare of any path in any G″(ad, imp) that connects the same pair of nodes. The revshares of optimal paths in G′(imp), therefore, are upper bounds (UBs) on the revshares of optimal paths in every ad-specific graph G″(ad, imp).

These revshare UBs are valuable because they can be multiplied by bids to produce payout UBs that can be compared with a payout lower bound (LB) (established by the payout of any legal ad-path pair) to prove that certain ads cannot win the auction via any legal path. Any such guaranteed-to-lose ad can be discarded without performing a best path computation in its respective G″(ad, imp).

Much work can be avoided if the candidate ads are processed in an order that causes the payout LB to rise quickly. An ordering heuristic scheme for achieving this is to sort and then consider the ads in decreasing order of bid multiplied by revshare upper bound (UB). If only a<<A ads typically end up requiring optimal path computations, then the typical run time would be the much more acceptable a Õ(E). However, the worst-case run time would still be Õ(A·E), so for improved operability, the serving system may contain an “operability knob” (k) that imposes a hard limit on the number of best path computations per ad call. Then the run time would be the effectively linear min(a, k)·Õ(E).

In graph theory, reachability is the notion of being able to get from one vertex (or node) in a directed graph to some other vertex (or node). Note that reachability in undirected graphs is trivial: it is sufficient to find the connected components in the graph, which can be done in linear time. For a directed graph D=(V, A), the reachability relation of D is the transitive closure of its arc set A, which is to say the set of all ordered pairs (s, t) of vertices (nodes) in V for which there exist vertices ν₀=s, ν₁, . . . , ν_{d}=t such that (νᵢ₋₁, νᵢ) is in A for all 1≦i≦d.

Algorithms for reachability fall into two classes: those that require pre-processing and those that do not. For the latter case, resolving a single reachability query can be done in linear time using algorithms such as breadth first search (BFS) or iterative deepening depth-first search. These algorithms are contemplated by this disclosure when “reachability” or “reachable” is referred to herein.

Major steps of the core algorithm executable by the ad exchange server 120, not all of which have to be executed for a functioning, useful algorithm, and their approximate costs include those listed below.

Step 1: Extract partially thinned subgraph G′(imp) by copying or marking nodes and edges that are reachable from the current publisher and are legal for the current impression (display opportunity). Cost: O(E).

Step 2: Use a minimum-cost-path algorithm such as single-source Dijkstra to compute optimal paths in G′(imp), connecting every advertiser to the publisher, and establishing upper bounds on the revshare of the corresponding paths in each respective ad-specific graph, G″(ad,imp). Cost: Õ(E).

Step 3: Evaluate legality of all reachable ads. Cost: Õ(A).

Step 4: For all legal ads, get bids by calling a local or external bidding service, then multiply by the upper bounds (UBs) on revshare, obtaining upper bounds on every pubPay(ad), and finally sort the ads in decreasing order of these bounds. Cost: Õ(A). Calling a bidding service is the action of the ad exchange server 120 calling out for bids from the advertisers 104. A bidding service, whether internal to the exchange or external (third party), may implement any strategy (as in game theory strategy) on behalf of a buyer, typically optimizing a given utility or objective function. The NGD Exchange 120 supports various advertisement campaign pricing types such as CPM (cost-per-mille), CPC (cost-per-click) or CPA (cost-per-action), however, in order to participate in the auction, bids are normalized by the bidding service to a common estimated CPM (eCPM) “currency,” making use of response prediction models to compute the estimated probability that the user will respond to an ad via a click or an action.

Step 5: For each ad in a prefix of the sorted list, if the ad is still viable according to the bounds, use single-source, single-sink Dijkstra to compute an optimal path in the ad-specific graph, G″ (ad, imp). This produces a completely legal path and a corresponding value for pubpay(ad,path), and may result in an updated lower bound (LB). Stop after min(a, k) path computations, and serve the highest-paying (ad,path) pair so far. Cost: min(a, k)·Õ(E).

In some embodiments, upper and lower bounds need not be used as described in Steps 1-5, yet partially-thinned subgraph G′(imp) may still be extracted and optimal paths therethrough still computed.

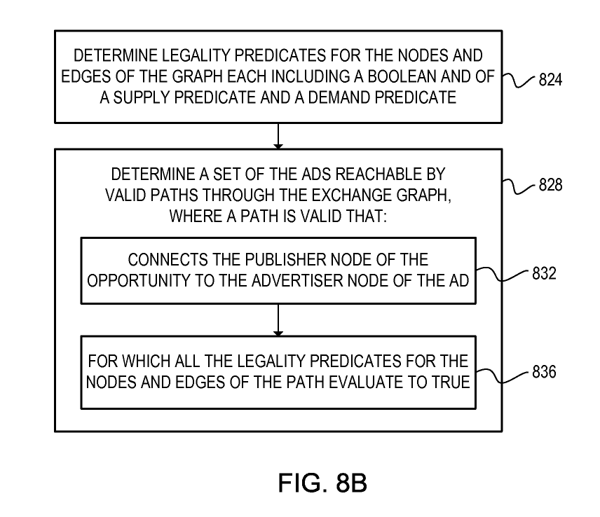

FIGS. 7A, 7B, 7C, and 7D is a series of related diagrams of exchange graphs 600, showing the progression of a core algorithm for ad selection of a sample ad in an ad exchange with intermediate ad-network entities. FIG. 7A is an exchange graph (G) containing two publisher nodes, four ad-network nodes, and three advertiser nodes each contributing one ad to the ad pool. Each graph edge has a revshare multiplier as indicated by “r” along the edges. Two of the edges are annotated by legality predicates (ohio & notFlash and !ohio) referring to properties of impressions and ads. Now suppose that publisher P1 gets an impression for a user that lives in Ohio.

Step 1 computes the partially thinned graph G′(imp) which appears in FIG. 7B. Notice that A2 and ad2 have disappeared, because the predicate notOhio(imp) on edge N2-A2 was not satisfied. Also, the predicate on edge N1-N3 has been simplified by omitting the already-satisfied predicate Ohio(imp).

Step 2 uses single-source Dijkstra to compute the provisional best path tree drawn in solid lines in FIG. 7B, plus upper bounds on the revshare of legal paths between the publisher and all advertisers. These upper bounds turn out to be 0.5 for both A1 and A3. The computations in Steps 3 and 4 then yield the following sorted list of ad candidates: [(ad3, bid=$16, pubPayUB=$8); (ad1, bid=$6, pubPayUB=$3)].

In Step 5, Ad3 is therefore processed first. Conceptually, the graph G″(ad3, imp) shown in FIG. 7C is constructed. The edge N1-N3 has disappeared because notFlash(ad3) is false. This invalidates the provisional best path to A3, which was responsible for the revshare UB of 0.5. A single-source, single-sink Dijkstra computation, this time run on G″(ad3, imp), finds a new best path between P1 and A3. Its revshare is 0.25, so the final payment to the publisher is pubpay(ad3)=$4. This payment also updates the lower bound pubPayLB, which controls the skipping of subsequent ad candidates. In this example, pubPayUB(ad1)=$3<pubPayLB=$4, so Ad1 can in fact be discarded without performing a best path computation in G″(ad 1, imp).

For completeness this (unnecessary) graph G″(ad1, imp) is provided as FIG. 7D, as well as the optimal legal path that the single-source, single-sink Dijkstra would have found. This turns out to be the same as the provisional best path for ad1, so pubPayUB(ad1) was tight in this case.

The present embodiments also disclose how to modify intractable features to make them tractable. These features were temporarily removed to create the efficiently solvable “core problem” discussed above. Then, features that encoded important business logic were re-introduced in limited forms that do not cause intractability, but do cover the most important use-cases. In many cases, the limitation was to reduce the scope of the applicability of a feature to small regions of the graph containing the publisher nodes and advertiser nodes, where business logic is most important. These regions were collectively named the “end zone” of the graph during negotiations with the business for permission to make these changes.

In a few cases, brute force methods were then used to implement the residual features, but they technically did not re-introduce an exponential run time because the search is over a limited number of possibilities. However, these methods do cause the constant factors of the algorithm and the order of the polynomial to be worse than those of the core algorithm discussed earlier. Discussed now are three examples of formerly intractable features, in increasing order of their impact on the asymptotic run time of the above algorithm.

First are constraints where node x bans node y from the path. It is NP-hard to find paths respecting these constraints for general nodes x and y. However, the constraints can be easily enforced at negligible cost when at least one of x and y is a publisher node or an advertiser node, or the managing ad-network of one of those two nodes. Therefore, the disclosed algorithms, as executed by the ad exchange server 120, support this “end zone” case, but not node banning in general.

Second are second publisher edge priorities. Assumed is that if priorities were enforced on all graph edges they would cause intractability, so the ad exchange server 120 enforces them only on edges touching the current publisher node. This is done by running the complete algorithm multiple times, once for each priority value. This only affects the constant factor, but slowing the system down by a factor of, e.g., 10 would be unacceptable, so the ad exchange server 120 further limits the feature by only recognizing two priority values on publisher edges.

Third are constraints where edge x bans an adjacent edge y from the path. It is NP-hard to find simple paths respecting these constraints. However, possibly self-intersecting paths can be found using a modified Dijkstra implementation that potentially looks at every (in-edge, outedge) pair on every node where these constraints are being honored. Therefore, the cost of one optimal path computation is no longer Õ(E), but rather Õ(Σ_{nd} in deg(nd)·out deg(nd)). To reduce the cost in practice, and also because the business use-case is strongest there, the ad exchange server 120 only enforces these constraints for pairs of edges straddling ad-networks that are adjacent to the current publisher node or advertiser node.

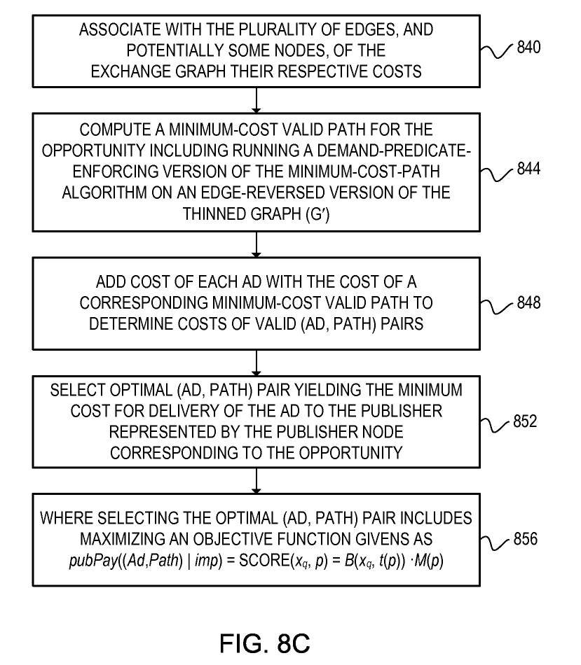

FIGS. 8A, 8B, and 8C are flow diagrams of an exemplary method for efficient ad selection in an ad exchange with intermediate ad-network entities 110 that expands on at least some of the steps of the “core algorithm” disclosed above. The method may be executed by the ad exchange server 120 with a processor and system storage, where the ad exchange server 120 may be coupled with the web server 118, as discussed above.

In block 800, the method constructs an exchange graph (G), in memory of the server, including nodes representing a plurality of publishers and advertisers, and one or more intermediate entities, the exchange graph also including a plurality of directed edges that represent bilateral business agreements connecting the nodes. In block 804, it receives an opportunity for displaying an ad to a user, where the opportunity is associated with a publisher node and includes properties that are targetable by a plurality of supply predicates, where a supply predicate includes a function whose inputs include properties of the user. At block 808, it retrieves a plurality of ads that are available for display to the user associated with respective advertiser nodes and that include properties that are targetable by a plurality of demand predicates, where a demand predicate includes a function whose inputs include properties of one or more of the plurality of ads. At block 812, it computes a thinned graph (G′) having fewer nodes by enforcing the supply predicates in the nodes and edges of the graph (G). At block 816, computing the thinned graph (G′) may include running a supply-predicate-enforcing version of a reachability algorithm, starting at the publisher node of the opportunity. And, at block 820, it produces a list of ads and corresponding paths that exist through the thinned graph (G′) to the opportunity that satisfy the plurality of demand predicates, and thus may be used to fill the display opportunity.

At block 824, the method determines a plurality of legality predicates for association with the nodes and edges of the graph, the legality predicates each including a Boolean AND (or other combination) of a supply predicate and a demand predicate. At block 828, to compute the thinned graph (G′) and produce the list of ads for the opportunity, the method determines a set of the ads reachable by valid paths through the graph (G), where a path is valid that, at block 832, connects the publisher node of the opportunity to the advertiser node of an ad; and, at block 836, for which all of the legality predicates for the nodes and edges evaluate to true.

At block 840, the method further associates with the plurality of edges, and potentially some nodes, of the graph their respective costs. At block 844, it computes a minimum-cost valid path for the opportunity comprising running a demand-predicate-enforcing version of a minimum-cost-path algorithm on an edge-reversed version of the thinned graph (G′), starting at each of at least some of the advertiser nodes. The edge costs may include a negative logarithm of a revenue share multiplier affiliated with respective edges, where the minimum-cost-path algorithm comprises Dijkstra's algorithm, and where the result of running Dijkstra's algorithm is a maximum revenue path, per impression, to the publisher node corresponding to the opportunity. At block 848, the method further adds the cost of each ad with the cost of a corresponding minimum-cost valid path to determine costs of valid (ad, path) pairs. At block 852, it selects the optimal (ad, path) pair yielding the minimum cost for delivery of the ad to the publisher represented by the publisher node corresponding to the opportunity.

At block 856, the method selects the optimal (ad, path) pair by maximizing an objective function given as Equation 1. Equation 1 may further be expressed in more detail as Equation 3, or Score(x_{q}, p)=B(x_{q}, t(p))·M(p), where bid B(x_{q}, tⱼ) is an offer by advertiser tⱼ to pay money for showing an ad to a user having properties x_{q}, where M(p) is given as Π_{eεp}m(e), a multiplier for an entire path where m(e) is a multiplier for a single edge lying in an interval (0,1), and where Score(x_{q},p) represents the money received by the publisher after some money is diverted to the intermediate business entities.

In executing the above core algorithm and the steps discussed above, the developers wanted to implement the third-party interface (3PI) 124 by keeping the existing graph exploration and subsequent auction algorithm substantially untouched. The 3PI 124 needs to send out bid requests and materialize real bids for the eligible third-party creatives of the third-party advertisers 106 just before the auction starts. Note that the system 100 does not want to call out to the third party advertisers 106 if they are not eligible to participate in the auction. To accomplish this, the exchange server 120 hooks into the graph exploration phase, collecting eligible third-party advertisers 106 as the exchange graph is traversed and avoiding evaluation of targeting predicates whenever possible. That is, if a bid call out for third party ads happens after evaluation of demand and/or supply predicates, then the call out will adversely affect end-to-end latency because the exchange server 120 has to include network round-trip times into the critical path for delivery of the ad.

One way of avoiding evaluation of at least some of the demand predicates, for instance, is to analyze, in real time, the selectivity statistics stored in the selectivity statistics database 170 in relation to the demand predicates. The selectivity statistics inform the exchange server 120 the chance that the demand predicate will be satisfied, and thus that an (ad, path) pair will be selected. The exchange server 120 then uses these statistics along with statistics of other, local ads, to decide latency budgets for different marketplaces. If a third-party ad is considered to have a low probability of being discarded due to demand predicates not being satisfied elsewhere, a speculative early bid call out is initiated to that third-party ad. This allows the system 100 to reduce the impact of network round-trips on the end-to-end latency while still ensuring that on average, the system 100 makes the bid call out only when the third party ad can participate in the auction. While the above-described process, cumulating in a speculative call out for bids to an advertiser, will save more time if done in relation to external third-party advertisers 106, it may also reduce latency for call outs to local advertisers 104 as well.

Accordingly, when the graph exploration is complete, the ad exchange server 120 will have a collection of third party advertisers 106 in addition to other local advertisers 104 to whom the exchange server 120 calls out for bids for the current opportunity. After the bids are received, the exchange server 120 inserts the bids and corresponding creative content at the appropriate advertiser nodes and allows the auction to start as before. The auction code is transparent to the fact that third-party creatives are involved.

In some embodiments, instead of the ad exchange server 120 calling out directly to the local and third-party advertisers 104, 106 for bids, it may first call a bid gateway 126, which then makes the ad call. The bid gateway 126 multiplies the processing power and resources available for performing the communication between the ad server 120 and the participants of the system 100, which may also include, in addition to the advertisers 104, 106, the users 112, the publishers 108, and the ad-network entities 110.

When used, the one or more bid gateway 126 is the main workhorse of the third party interface 124. The bid gateway 126 represents a high-performance implementation of the message broker pattern in enterprise integration architectures. The bid gateway 126 receives a bidding opportunity, scatters out bid requests to participating third party advertisers 106, gathers bid responses from all of the participants, enforces timeouts across all third party advertisers 106, and then sends the received bids back to the ad server 120. During this process, it enforces traffic shaping to each third party advertiser 106 and handles different failure modes gracefully.

The performance of the bid gateway 126 may have a large impact on latencies because it is in the critical path of the total latency for delivering the ad. The design is optimized to minimize latency overhead (<5 ms processing overhead) while supporting maximal throughput, which may be upwards of 1 k query per second (QPS) per host. The bid gateway 126 workload is primarily network bound due to the network amplifier nature of contacting multiple third party advertisers 106 in an ad call. Additionally, there is some CPU-intensive work per message due to signing, encryption, and serialization and de-serialization of the protocol messages. A relatively large fraction of the overall third-party interface latency for an opportunity is spent waiting for a response from third-party bidding agents that works on behalf of the third-party advertisers 106. This implies a large number of in-flight connections in the bid gateway 126 waiting for responses. The bid gateway 126 therefore uses an event-based asynchronous 10 framework with low latency overhead.

The benefits of service isolation prompted the separation of the ad exchange server 120 that implements the core business logic from the bid gateway 126 that implements a network conduit to feed third-party bids into the exchange server 120. Having a dedicated set of bid gateway hosts 126 enables management of the physical architecture and outbound connections much better, and also provides elasticity of scale independent of the ad server 120 both in terms of capacity and features. While the addition of one or more bid gateways 126 does introduce a measurable latency overhead, which is still less than 5 ms, the significant increase in QPS throughput—up to 8000 QPS across 11 bid gateways—outweighs the latency costs.

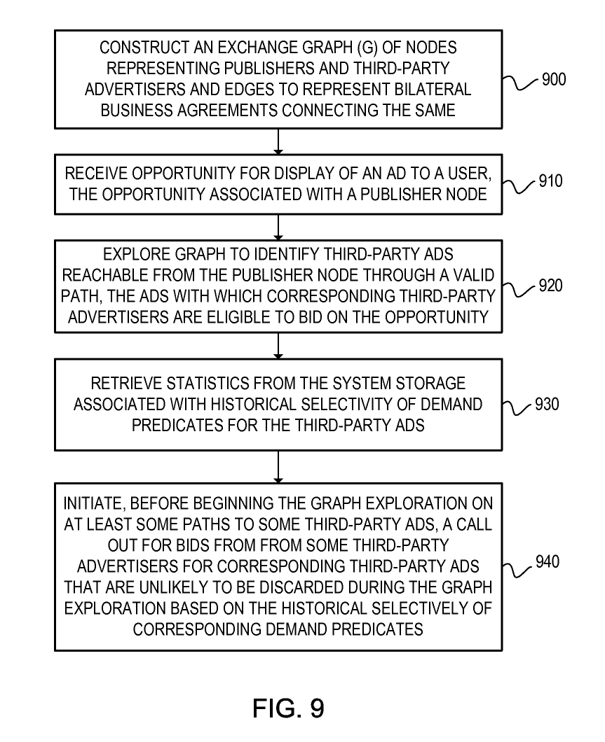

FIG. 9 is a flow chart of an exemplary method for conducting demand-side, real-time bidding in an ad exchange server. The method may be executed by an ad exchange server having a processor and system storage. At block 900, the server may construct an exchange graph (G) in memory that includes nodes representing a plurality of publishers and third-party advertisers, the third-party advertisers providing third-party advertisements (“ads”), the graph also including a plurality of directed edges connected between the nodes that represent bilateral business agreements. At block 910, the server may receive an opportunity for displaying an ad to a user, where the opportunity is associated with a publisher node. At block 920, the server may explore to identify specific third-party ads reachable from the publisher node through a valid path of the exchange graph, the specific third-party ads with which corresponding third-party advertisers are thereby eligible to bid on the opportunity. A valid path is a path through the graph for which a plurality of targeting predicates in the nodes and edges of the path are satisfied.

At block 930, the server may retrieve statistics from the system storage associated with historical selectivity of demand predicates for at least some of the plurality of third-party ads, where a demand predicate includes a function whose inputs include properties of one or more of the plurality of third-party ads. At block 940, the server may initiate, before beginning the graph exploration on at least some paths to the specific third-party ads, a call out for bids from at least some of the third-party advertisers for the corresponding third-party ads that are unlikely to be discarded during the graph exploration based on the historical selectively of the demand predicates corresponding thereto, thereby reducing latency in time to execute an auction to fill the display opportunity.

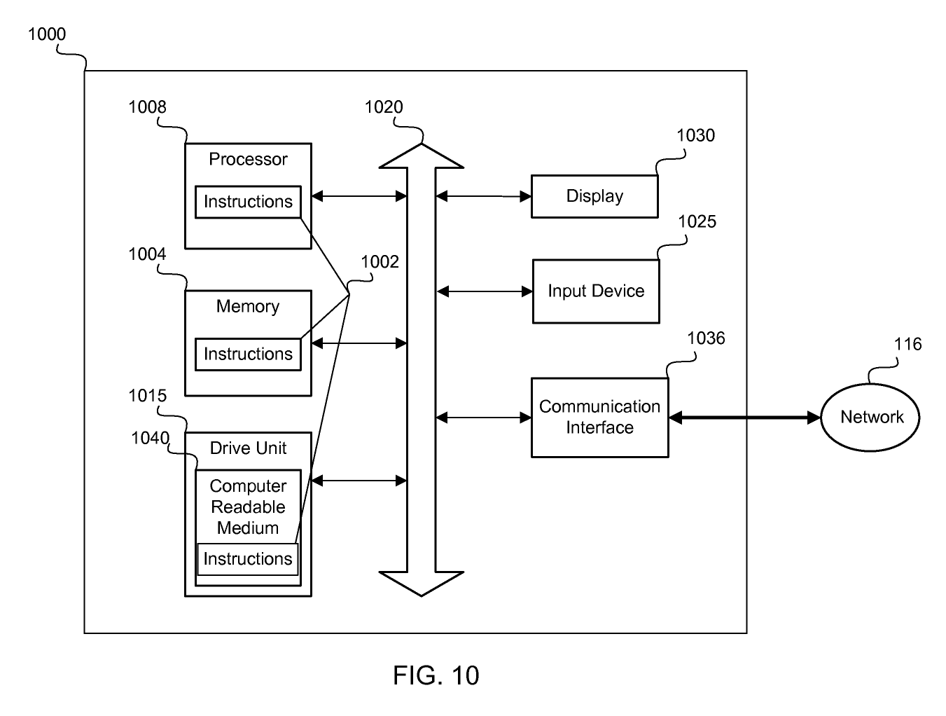

FIG. 10 illustrates a general computer system 1000, which may represent the web server 118, the ad exchange server 120, the third-party interface, the bid gateways 126, the user browser 114, or any other computing devices referenced herein, such as client computers of the users 112, the advertisers 104, 106, the publishers 108, and the ad-network entities 110. The computer system 1000 may include an ordered listing of a set of instructions 1002 that may be executed to cause the computer system 1000 to perform any one or more of the methods or computer-based functions disclosed herein. The computer system 1000 may operate as a stand-alone device or may be connected, e.g., using the network 116, to other computer systems or peripheral devices.

In a networked deployment, the computer system 1000 may operate in the capacity of a server or as a client-user computer in a server-client user network environment, or as a peer computer system in a peer-to-peer (or distributed) network environment. The computer system 1000 may also be implemented as or incorporated into various devices, such as a personal computer or a mobile computing device capable of executing a set of instructions 1002 that specify actions to be taken by that machine, including and not limited to, accessing the Internet or Web through any form of browser. Further, each of the systems described may include any collection of sub-systems that individually or jointly execute a set, or multiple sets, of instructions to perform one or more computer functions.

The computer system 1000 may include a memory 1004 on a bus 1020 for communicating information. Code operable to cause the computer system to perform any of the acts or operations described herein may be stored in the memory 1004. The memory 1004 may be a random-access memory, read-only memory, programmable memory, hard disk drive or any other type of volatile or non-volatile memory or storage device.

The computer system 1000 may include a processor 1008, such as a central processing unit (CPU) and/or a graphics processing unit (GPU). The processor 1008 may include one or more general processors, digital signal processors, application specific integrated circuits, field programmable gate arrays, digital circuits, optical circuits, analog circuits, combinations thereof, or other now known or later-developed devices for analyzing and processing data. The processor 808 may implement the set of instructions 1002 or other software program, such as manually-programmed or computer-generated code for implementing logical functions. The logical function or any system element described may, among other functions, process and/or convert an analog data source such as an analog electrical, audio, or video signal, or a combination thereof, to a digital data source for audio-visual purposes or other digital processing purposes such as for compatibility for computer processing.

The computer system 1000 may also include a disk or optical drive unit 1015. The disk drive unit 1015 may include a computer-readable medium 1040 in which one or more sets of instructions 1002, e.g., software, can be embedded. Further, the instructions 1002 may perform one or more of the operations as described herein. The instructions 1002 may reside completely, or at least partially, within the memory 1004 and/or within the processor 1008 during execution by the computer system 1000. Accordingly, the databases 140, 160, 162, 164, 166, and 170 described above in FIG. 1 may be stored in the memory 1004 and/or the disk unit 1015.

The memory 1004 and the processor 1008 also may include computer-readable media as discussed above. A “computer-readable medium,” “computer-readable storage medium,” “machine readable medium,” “propagated-signal medium,” and/or “signal-bearing medium” may include any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium.

Additionally, the computer system 1000 may include an input device 1025, such as a keyboard or mouse, configured for a user to interact with any of the components of system 1000. It may further include a display 1030, such as a liquid crystal display (LCD), a cathode ray tube (CRT), or any other display suitable for conveying information. The display 1030 may act as an interface for the user to see the functioning of the processor 1008, or specifically as an interface with the software stored in the memory 1004 or the drive unit 1015.

The computer system 1000 may include a communication interface 1036 that enables communications via the communications network 116. The network 116 may include wired networks, wireless networks, or combinations thereof. The communication interface 1036 network may enable communications via any number of communication standards, such as 802.11, 802.17, 802.20, WiMax, cellular telephone standards, or other communication standards.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein. Such a programmed computer may be considered a special-purpose computer.

The method and system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

As shown above, the system serving advertisements and interfaces that convey additional information related to the advertisement. For example, the system generates browser code operable by a browser to cause the browser to display a web page of information that includes an advertisement. The advertisement may include a graphical indicator that indicates that the advertisement is associated with an interface that conveys additional information associated with the advertisement. The browser code is operable to cause the browser to detect a selection of the graphical indicator, and display the interface along with the information displayed on the web page in response to the selection of the graphical indicator. The advertisement and the additional information conveyed via the interface are submitted by an advertiser during an advertisement submission time.

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present embodiments are to be determined by the broadest permissible interpretation of the following claims and their equivalents, and shall not be restricted or limited by the foregoing detailed description. While various embodiments have been described, it will be apparent to those of ordinary skill in the art that many more embodiments and implementations are possible within the scope of the above detailed description. Accordingly, the embodiments are not to be restricted except in light of the attached claims and their equivalents.

1. A method for conducting demand-side, real-time bidding in an ad exchange server having a processor and memory, comprising:
constructing an exchange graph (G), in memory of the server, including nodes representing a plurality of publishers and third-party advertisers, the third-party advertisers providing third-party advertisements (“ads”), the graph also including a plurality of directed edges connected between the nodes that represent bilateral business agreements;
receiving, by the server, an opportunity for displaying an ad to a user, where the opportunity is associated with a publisher node;
exploring the graph, by the server, to identify specific third-party ads reachable from the publisher node through a valid path of the exchange graph, the specific third-party ads with which corresponding third-party advertisers are thereby eligible to bid on the opportunity, where a valid path is a path through the graph for which a plurality of targeting predicates in the nodes and edges of the path are satisfied;
retrieving, by the server, statistics from the memory associated with historical selectivity of demand predicates for at least some of the plurality of third-party ads, where a demand predicate comprises a function whose inputs include properties of one or more of the plurality of third-party ads; and
initiating, by the server before beginning the graph exploration on at least some paths to the specific third-party ads, a call out for bids from at least some of the third-party advertisers for the corresponding third-party ads that are unlikely to be discarded during the graph exploration based on the historical selectively of the demand predicates corresponding thereto, thereby reducing latency in time to execute an auction to fill the display opportunity.

2. The method of claim 1, where the plurality of third-party ads further include a plurality of local ads, and the statistics further relate to the plurality of local ads, the method further comprising:
estimating, by the server during exploration of the graph, latencies through the graph from the publisher node having the opportunity to respective local ads and third-party ads based on the statistics; and
deciding whether to call out for a bid to specific third-party or local ads based on the estimated latencies.

3. The method of claim 1, where the server further comprises a bid gateway coupled with the server, where the bid gateway executes the retrieving and the initiating steps, and passes along the bid call out as directed by the server.

4. The method of claim 1, where the historical selectivity of the demand predicates for the third-party ads comprises a probability that each of at least some of the third-party ads will outbid the other third-party advertisers for the opportunity.

5. The method of claim 1, where the plurality of targeting predicates include the demand predicates and a plurality of supply predicates, where the publisher node includes properties that are targetable by the supply predicates, where a supply predicate comprises a function whose inputs include properties of the user, and where the edges of the graph are associated with one or more selected from the group consisting of a demand predicate and a supply predicate.

6. The method of claim 5, where the plurality of third-party ads further include a plurality of local ads, and where a reachable, valid path comprises a path through the graph that: connects the publisher node of the opportunity to the advertiser node of a local or third-party ad, and for which all of the demand and supply predicates of the nodes and edges of the graph are satisfied.

7. The method of claim 6, where the historical selectively of the demand predicates for the third-party ads comprises:
a probability of finding a valid path from the publisher node to a node of the third-party ad; and
an estimation of at what point in time during the exploration of the graph (G) that the demand and supply predicates will be satisfied.

8. The method of claim 6, where exploring the graph (G) comprises:
computing, by the server, a thinned graph (G′) by enforcing the supply predicates in the nodes and edges of the graph (G) comprising running a supply-predicate-enforcing version of a reachability algorithm, starting at the publisher node of the opportunity; and
producing, by the server, a list of local and third-party ads and corresponding paths that exist through the thinned graph (G′) to the opportunity that satisfy the plurality of demand predicates.

9. A system comprising an ad exchange server having a processor and memory, where the processor is configured to:
construct an exchange graph (G), in memory of the server, including nodes representing a plurality of publishers and third-party advertisers, the third-party advertisers providing third-party advertisements (“ads”), the graph also including a plurality of directed edges connected between the nodes that represent bilateral business agreements;
receive an opportunity for displaying an ad to a user, where the opportunity is associated with a publisher node;
explore the graph to identify specific third-party ads reachable from the publisher node through a valid path of the exchange graph, the specific third-party ads with which corresponding third-party advertisers are thereby eligible to bid on the opportunity, where a valid path is a path through the graph for which a plurality of targeting predicates in the nodes and edges of the path are satisfied;
retrieve statistics from the memory associated with historical selectivity of demand predicates for at least some of the plurality of third-party ads, where a demand predicate comprises a function whose inputs include properties of one or more of the plurality of third-party ads; and
initiate, before beginning the graph exploration on at least some paths to the specific third-party ads, a call out for bids from at least some of the third-party advertisers for the corresponding third-party ads that are unlikely to be discarded during the graph exploration based on the historical selectively of the demand predicates corresponding thereto, thereby reducing latency in time to execute an auction to fill the display opportunity.

10. The system of claim 9, where the plurality of third-party ads further include a plurality of local ads, and the statistics further relate to the plurality of local ads, the processor further configured to:
estimate, during exploration of the graph, latencies through the graph from the publisher node having the opportunity to respective local ads and third-party ads based on the statistics; and
decide whether to call out for a bid to specific third-party or local ads based on the estimated latencies.

11. The system of claim 9, further comprising a bid gateway coupled with the server, where the bid gateway is configured to:
execute the retrieving and the initiating steps;
pass along the bid call out as directed by the server to corresponding third-party advertisers;
receive bid responses from the third-party advertisers; and
enforce timeouts with regards to time taken to respond by the third-party advertisers.

12. The system of claim 9, where the historical selectivity of the demand predicates for the third-party ads comprises a probability that each of at least some of the third-party ads will outbid the other third-party advertisers for the opportunity.

13. The system of claim 9, where the plurality of targeting predicates include the demand predicates and a plurality of supply predicates, where the publisher node includes properties that are targetable by the supply predicates, where a supply predicate comprises a function whose inputs include properties of the user, and where the edges of the graph are associated with one or more selected from the group consisting of a demand predicate and a supply predicate.

14. The system of claim 13, where the plurality of third-party ads further include a plurality of local ads, and where a reachable, valid path comprises a path through the graph that: connects the publisher node of the opportunity to the advertiser node of a local or third-party ad, and for which all of the demand and supply predicates of the nodes and edges of the graph are satisfied.

15. The system of claim 14, where the historical selectively of the demand predicates for the third-party ads comprises:
a probability of finding a valid path from the publisher node to a node of the third-party ad; and
an estimation of at what point in time during the exploration of the graph (G) that the demand and supply predicates will be satisfied.

16. The system of claim 14, where the processor is further configured to explore the graph (G) by:
computing a thinned graph (G′) by enforcing the supply predicates in the nodes and edges of the graph (G) comprising running a supply-predicate-enforcing version of a reachability algorithm, starting at the publisher node of the opportunity; and
producing a list of local and third-party ads and corresponding paths that exist through the thinned graph (G′) to the opportunity that satisfy the plurality of demand predicates.

17. A computer-readable storage medium comprising a set of instructions for conducting demand-side, real-time bidding in an ad exchange server having a processor and memory, the computer-readable medium comprising:
instructions to direct the processor to construct an exchange graph (G) including nodes representing a plurality of publishers and third-party advertisers, the third-party advertisers providing third-party advertisements (“ads”), the graph also including a plurality of directed edges connected between the nodes that represent bilateral business agreements;
instructions to direct the processor to receive an opportunity for displaying an ad to a user in response to an action by the user with reference to a web page associated with a publisher node;
instructions to direct the processor to explore the graph to identify specific third-party ads reachable from the publisher node through a valid path of the exchange graph where a valid path is a path through the graph for which a plurality of targeting predicates in the nodes and edges of the path are satisfied;
instructions to direct the processor to retrieve statistics from the memory associated with historical selectivity of demand predicates for at least some of the plurality of third-party ads, where a demand predicate comprises a function whose inputs include properties of one or more of the plurality of third-party ads; and
instructions to direct the processor to initiate, before beginning the graph exploration on at least some paths to specific third-party ads, a call out for bids from at least some of the third-party advertisers for the corresponding third-party ads that are unlikely to be discarded during the graph exploration based on the historical selectively of the demand predicates corresponding thereto, thereby reducing latency in time to execute an auction to fill the display opportunity.

18. The computer-readable storage medium of claim 17, where the plurality of third-party ads further include a plurality of local ads, and the statistics further relate to the plurality of local ads, the computer-readable storage medium further comprising:
instructions to direct the processor to estimate, during exploration of the graph, latencies through the graph from the publisher node having the opportunity to respective local ads and third-party ads based on the statistics; and
instructions to direct the processor to decide whether to call out for a bid to specific third-party or local ads based on the estimated latencies.

19. The computer-readable storage medium of claim 17, where the server further comprises a bid gateway coupled with the server, where the bid gateway executes the retrieving and the initiating steps, and passes along the bid call out as directed by the server.

20. The computer-readable storage medium of claim 17, where the historical selectivity of the demand predicates for the third-party ads comprises a probability that each of at least some of the third-party ads will outbid the other third-party advertisers for the opportunity.

21. The computer-readable storage medium of claim 17, where the plurality of targeting predicates include the demand predicates and a plurality of supply predicates, where the publisher node includes properties that are targetable by the supply predicates, where a supply predicate comprises a function whose inputs include properties of the user, and where the edges of the graph are associated with one or more selected from the group consisting of a demand predicate and a supply predicate.

22. The computer-readable storage medium of claim 21, where the plurality of third-party ads further include a plurality of local ads, and where a reachable, valid path comprises a path through the graph that: connects the publisher node of the opportunity to the advertiser node of a local or third-party ad, and for which all of the demand and supply predicates of the nodes and edges of the graph are satisfied.

23. The computer-readable storage medium of claim 22, where the historical selectively of the demand predicates for the third-party ads comprises:
a probability of finding a valid path from the publisher node to a node of the third-party ad; and
an estimation of at what point in time during the exploration of the graph (G) that the demand and supply predicates will be satisfied.

24. The computer-readable storage medium of claim 22, further comprising:
instructions to direct the processor to compute a thinned graph (G′) by enforcing the supply predicates in the nodes and edges of the graph (G) comprising running a supply-predicate-enforcing version of a reachability algorithm, starting at the publisher node of the opportunity; and
instructions to direct the processor to produce a list of local and third-party ads and corresponding paths that exist through the thinned graph (G′) to the opportunity that satisfy the plurality of demand predicates.
